(19) United States
(12) Patent Application Publication
(10) Pub. No.: US 2013/0266290 A1
(43) Pub. Date: Oct. 10, 2013

(54) METHOD AND APPARATUS FOR CREATING MEDIA EDITS USING DIRECTOR RULES

(71) Applicant: Sailesh Kumar Sathish, Tampere (FI)

(72) Inventor: Sailesh Kumar Sathish, Tampere (FI)

(73) Assignee: Nokia Corporation, Espoo (FI)

(21) Appl. No.: 13/440,001

(22) Filed: Apr. 5, 2012

(51) Int. Cl. H04N 5/93

(52) U.S. Cl. 386/278; 386/E05.028

(57) ABSTRACT

An approach is provided for determining heuristic information for creating at least one media compilation, wherein the heuristic information is associated with at least one directing user. A processer may determine a selection of the heuristic information by at least one end user and process and/or facilitate a processing of the heuristic information to cause, at least in part, a creating of the at least one media compilation based, at least in part, on one or more media items associated with the at least one end user.

### BACKGROUND

Service providers and device manufacturers (e.g., wireless, cellular, etc.) are continually challenged to deliver value and convenience to consumers by, for example, providing compelling network services. One area of interest has been the development of automating media cuts. For example, systems increasingly create multimedia by automating editing from multiple video sources. However, the editing does not take into account directorial skill or talent. There is yet no automated media editing that distinguishes between editing skill of novice, experienced users, and/or professional levels. Because there historically have been few if any methods to provide directorial rules or heuristics for editing media, there is no system that can distinguish between different types of video and choose directional heuristics based on directorial skill in given types of video. Furthermore, there is no system capable of choosing raw videos or cuts based on user preferences and past actions to filter editing methods. There is also no way to monetize the editing process based on directorial skill. As such, service providers and device manufacturers face significant technical challenges to producing multimedia edited according to directorial skill.

### SOME EXAMPLE EMBODIMENTS

Therefore, there is a need for an approach for editing media according to directorial heuristics.

According to one embodiment, a method comprises determining heuristic information for creating at least one media compilation, wherein the heuristic information is associated with at least one directing user. The method also comprises determining a selection of the heuristic information by at least one end user. The method further comprises processing and/or facilitating a processing of the heuristic information to cause, at least in part, a creation of the at least one media compilation based, at least in part, on one or more media items associated with the at least one end user.

According to another embodiment, an apparatus comprises at least one processor, and at least one memory including computer program code for one or more computer programs, the at least one memory and the computer program code configured to, with the at least one processor, cause, at least in part, the apparatus to determine heuristic information for creating at least one media compilation, wherein the heuristic information is associated with at least one directing user. The apparatus is also caused to determine a selection of the heuristic information by at least one end user. The apparatus is further caused to process and/or facilitate a processing of the heuristic information to cause, at least in part, a creation of the at least one media compilation based, at least in part, on one or more media items associated with the at least one end user.

According to another embodiment, a computer-readable storage medium carries one or more sequences of one or more instructions which, when executed by one or more processors, cause, at least in part, an apparatus to determine heuristic information for creating at least one media compilation, wherein the heuristic information is associated with at least one directing user. The apparatus is also caused to determine a selection of the heuristic information by at least one end user. The apparatus is further caused to process and/or facilitate a processing of the heuristic information to cause, at least in part, a creation of the at least one media compilation based, at least in part, on one or more media items associated with the at least one end user.

According to another embodiment, an apparatus comprises means for determining heuristic information for creating at least one media compilation, wherein the heuristic information is associated with at least one directing user. The apparatus also comprises means for determining a selection of the heuristic information by at least one end user. The apparatus further comprises means for processing and/or facilitating a processing of the heuristic information to cause, at least in part, a creation of the at least one media compilation based, at least in part, on one or more media items associated with the at least one end user.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of editing media according to directorial heuristics, according to one embodiment;

FIG. 2A is a diagram of the components of the heuristic platform that creates the directional heuristics, according to one embodiment;

FIG. 2B is a diagram of the components of the selection platform that permits selection of directorial heuristics to apply to editing media, according to one embodiment;

FIG. 3 is a flowchart of a process for editing media according to directional heuristics, according to one embodiment;

FIG. 4 is a flowchart of a process for causing categorization of heuristic information, according to one embodiment;

FIG. 5 is a framework for executing the processes of FIGS. 3-4, according to one embodiment;

FIG. 6 is a tree structure for categorizing heuristic information, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for editing media according to directorial heuristics are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

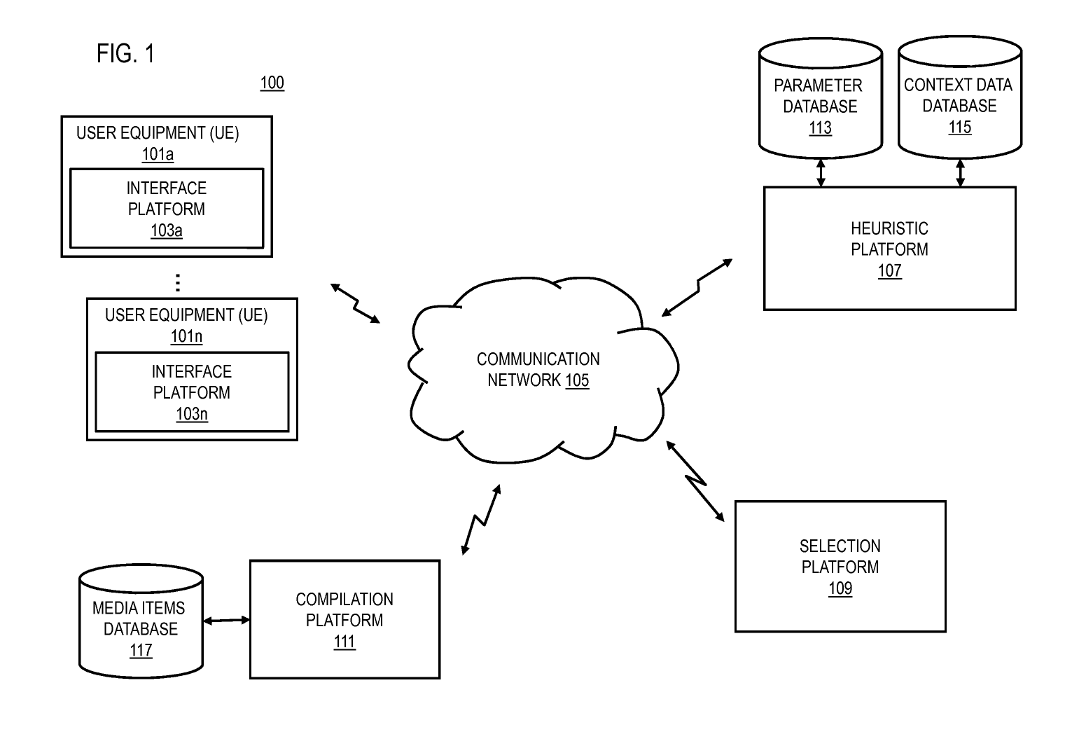

FIG. 1 is a diagram of a system capable of editing media according to directorial heuristics, according to one embodiment. As discussed, recent technological advances and developments have increased demand for sophisticated media editing options. However, there is yet no integration of media editing with directorial skill. In other words, there is no way to provide editing based on directorial skill, such as novice, experienced, or professional level editing. Additionally, editing currently does not take into account user preferences or past actions to recommend raw videos or cuts. Furthermore, automated editing does not yet provide for recommending editing heuristics based on the type of media being produced, and the directorial savvy available for the specific type of media produced. As such, there is no way to monetize automated editing for different directorial skill levels either.

To address this problem, a system 100 of FIG. 1 introduces the capability to edit media according to directional heuristics. In the system 100, directing users may provide directional heuristics and end users may receive media edited with the directional heuristics from directing users. End users may submit raw media for system 100 to edit using the directional heuristics contained in system 100. System 100 may determine heuristic information for creating at least one media compilation, wherein the heuristic information is associated with at least one directing user. In one embodiment, system 100 determines a selection of the heuristic information by at least one end user by directly prompting the end user to select the information. In another embodiment, system 100 determines the selection of heuristic information based on media submitted by the end user, user history, user preferences, or a combination thereof. Then, the system 100 creates at least one media compilation by processing the heuristic information selected.

The system 100 may gather directional heuristics a number of ways. In one embodiment, the system 100 may prompt directing users to fill out one or more templates for the directing users to enter values or ranges for various media editing parameters. Example parameters may include audio beats, fade effects, significant events, camera angle, duration, light range, ratios (people versus structures), panning, tilt, precision, multi-channels versus single channels, object detection and priority, target audience, event types, etc. Event types may include sport, personal home user, personal vacations, school, driving, public functions, etc. The content of the template may generate heuristic information for creating at least one media compilation associated with respective directing users.

Heuristic information may take many forms. In one scenario, heuristic information may include direction such as, switch to a second camera angle on the second beat of an audio file or given time stamp. Heuristic information may also pertain to how transitions take place or special effects for the transitions. Furthermore, heuristic information may relate to significant events in media clips. For instance, various sensors such as maturation data, gyroscope data, photo editing data, may indicate if one or more significant events took place within a frame. This may be indicated by a significant change in magnetometer data simultaneously by a significant number of users in crowd sourced media. Heuristic information may dictate how much of the clip to include in a media compilation, or the duration of the clip. Metadata may also detect parameters such as lighting, where heuristic information may call for one or more frames to be included or excluded in compilations due to lighting specifications. Other heuristic information may inform editing by designating rules around directing such as panning speed or timing, how much of frames or significant events to accommodate, quantity of tilt, etc. In some scenarios, setting parameter values or ranges may involve only metadata. These cases may permit lower system computation since the system 100 needs only to process metadata associated with one or more media items.

In this embodiment, the system 100 may further prompt directing users to specify a criteria or field that corresponds to the heuristic information. Criteria may include target audience, event type, media purpose, etc. For instance, system 100 may prompt users to determine whether heuristic information pertains to teens, general, or others, a wedding event, concert event, or sports event, or a movie, film short, or news report. In one scenario, the system 100 may display only the parameters that correspond to the criteria chosen so that the template does not have to display all the parameters at one time. In other words, in some scenarios, the templates can correspond to criteria chosen. In one example case, the “sports” template may display a subset of parameters that varies from the “concert” template. Alternately, the system 100 may display a parameter index for directing users to complete.

For one example, heuristic information associated with certain types of events may include information on length of clips to use, camera angles, when to switch cuts, and/or how to switch cuts may vary by event type. For one such instance, heuristic information for a concert media compilation may include information on how much of the stage to include in a shot, how much of the audience to include in a shot, and when to switch from a stage shot to an audience shot. Additionally, the heuristic information for concert compilations may permit a greater camera angle for some shots from the standpoint of an audience member looking up at a stage, whereas a personal vacation compilation may not employ a clip where a camera is similarly angled. In one scenario, end users may also designate criteria from the same categories for parts of their media compilation. For such a case, an end user may designate the first three minutes of their media compilation to be edited with heuristic information associated a “professional” directing user, and the next three minutes to heuristic information associated with an “amateur” directing user.

In addition, system 100 may prompt directing users to provide credibility information regarding directorial skill level, such as past experiences, ratings data, creativity, etc. Alternately, system 100 may determine directorial skill level by processing one or more media submissions from one or more respective directing users. In one scenario, the system 100 associates each media and/or heuristic information submission with the submitting directing user. In such a scenario, the system 100 may further associate media and/or heuristic information with the user profile of the submitting directing user. Accordingly, the system 100 does not have to prompt users to enter templates each time. The system 100 may save templates and heuristic information associated with directing users for continual use.

In one embodiment, the system 100 may organize the criteria for categorization of heuristic information into a tree structure. For example, the system 100 may maintain a categorization of the criteria that shows the availability of heuristic information for a particular type of media. In other words, system 100 may use the tree structure to provide users with categories of heuristic information in order to select heuristic information that most closely reflects the desired edited compilation. System 100 may then run the heuristic information associated with the criteria selected through raw media to generate at least one media compilation.

In one embodiment, the criteria may include rating information for classifying directing users. One such classification may be a standard rating of one to five stars. Alternately, the classification may consist of categories, such as amateur, expert, professional, etc. As previously discussed, the system 100 may associate heuristic information with user profile information. As such, the system 100 may also store account and/or ranking information and recommend heuristic information based on criteria chosen for the media compilation. In one embodiment, skill levels associated with directing users are not verified. However, heuristic information associated with the directing users are automatically also associated with the directing user's skill level. In certain embodiments, the system 100 may upgrade the skill level classification based on the directing user's contributions and/or ratings.

In one instance, the system 100 may also process raw media submitted by end users to recommend heuristic information. This processing may be in place or in addition to prompting end users to enter criteria suitable for the media compilation. In one such scenario, the system 100 may detect that, based on a given end user's history, the end user wants to upload videos to the Internet quickly. Speed is a priority over a polished product. Taking this into account, the system 100 may recommend criteria and/or heuristic information associated with more amateur editing skill that suits the user's preferences. Alternately, the system 100 may find that a given user is a professional wedding videographer. The quality of the video takes precedence, so the system 100 may accordingly make recommendations of professional level editing heuristic information. In another scenario, the system 100 may recognize a given directing user as having particularly high ratings for media compilations for a certain type of event. If the end user is creating a media compilation for that event, the system 100 may recommend the directing user and/or a set of heuristic information associated with the directing user.

As an alternative or addition to gathering directional heuristics via templates, system 100 may also create templates off submissions from users. In one embodiment, directing users may submit media files to system 100, and system 100 may generate a template from the media files directly. In a further embodiment, the system 100 may infer heuristic information from the media files directly, replacing the step of prompting directing users to enter heuristic information into a template. In one embodiment, end users may also add to or modify parts of heuristic information. In yet another embodiment, system 100 may provide users with sets of media, where the users may experiment with parameters and establish heuristic information to their liking. Recommendations to end users regarding heuristic information may apply, regardless of how the heuristic information is gathered.

Directing users may also be end users, and vice versa. For instance, system 100 may also make media compilations for directing users as end users and end users may create their own heuristic information or directional rules. As discussed, new directing users may receive free content and try different heuristics to create sets of heuristic information. In another embodiment, the system 100 may preselect a set of raw videos and submit heuristic information based on user preference, criteria available, and/or past user history. In one instance, the heuristic information may already be categorized by criteria. In doing so, the system 100 may recommend heuristic information based on existing knowledge of the user and present the information to the user. Furthermore, the system 100 may permit users to seek or build additional heuristic information to their satisfaction. In one scenario, the system 100 may insert set heuristic information and criteria into media files in various formats such as mp4 files. With this information, the system 100 may preselect various other heuristics and directorial rules into raw media to make the resulting media compilations.

In another further embodiment, the system 100 may associate one or more payment systems with heuristic information associated with directing users. For instance, the system 100 may require end users to pay to use heuristic information associated with “professional” directing users. For example, if a set of heuristic information is associated with a famous Hollywood director, an end user may have to pay the system 100 to use the heuristic information to produce his media compilation of a family vacation. In one such scenario, the resulting media compilation may carry one or more marks associated with the directing user. In another scenario, professional entities that created sets of heuristic information could also provide associated services, such as hosting and/or advertising the media compilations made with their sets of heuristic information. A payment system may also exist for providing such extensions of services after creating the media compilations. For these payment systems, system 100 may permit use of paid services to be gifted between users.

As shown in FIG. 1, the system 100 comprises a user equipment (UE) 101 (or UEs 101a-101n) having connectivity to an interface platform 103 (or interface platforms 103a-103n), heuristic platform 107, selection platform 109, compilation platform 111, parameter database 113, context data database 115, and media items database 117 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the interface platforms 103 may interact with the heuristic platform 107 and selection platform 109 to generate user interfaces for users to create heuristic information for making media compilations. In one such embodiment, the heuristic platform 107 may create the directional heuristics, or determine the heuristic information that is associated with directing users. As discussed above, the heuristic platform 107 may determine the heuristic information associated with directing users by prompting directing users to complete one or more templates and/or processing media items submitted by directing users to infer heuristic information. The parameter database 113 may contain a collection of possible parameters, or an index of parameters. The heuristic platform 107 may interact with the parameter database 113 to create one or more templates. Alternately, the heuristic platform 107 may also work with the context data database 115 to build on existing parameter values, creating additional framework for making automated edits towards constructing media compilations. In one instance, the heuristic platform 107 work with the context data database 115 in conjunction with the media items database 117 via communication network 105 to determine heuristic information associated with data and metadata supplied from the context data database 115 and media items database 117.

In one embodiment, the selection platform 109 may categorize the heuristic information according to one or more criteria so that users may better select heuristic information for creating the media compilation. The selection platform 109 may organize the categorization based on a tree structure and work with interface platforms 103 to create user interfaces for end users to select criteria suiting their media compilation needs. For instance, criteria existing in the selection platform 109 may be “event type”, “target audience” and “directorial skill.” Under the event type, “concert,” the selection platform 109 may maintain for target audience, “teen” and “general.” Such a tree structure may differ from a tree structure for event type, “wedding,” for instance, where there may be just the “general” target audience.

Such a tree structure may reflect the scenario where media compilations of concerts for teens typically are edited with heuristic information that provide for more shots of the audience and/or more frantic cuts relative to concert media compilations for the general audience. Continuing with the example, selection platform 109 may provide various directorial skill levels for the “general” audience and provide only “amateur” for the teen target audience. Such a tree structure may correspond to teens using the media compilations mostly to proliferate the feeling of the concert, whereas the general audience may want a higher quality media compilation as a collectors' edition. Likewise, the tree structure for the “wedding” event type may only have one option for target audience because there is typically little distinction in how people want their weddings to be presented. Of course, a couple could also select the “concert” setting to edit their wedding footage. Selections are up to users of UEs 101.

Furthermore, the selection platform 109 may associate ratings information or payment systems with various criteria, as previously discussed. For instance, the selection platform 109 may determine organization of directing users in the tree structure based on ratings information received from UEs 101. For such a scenario, the interface platform 103 may generate one or more user interfaces for end users to rate their media compilations and/or the directorial skill of the directing user whose heuristic information was used to create the media compilations. Also, the selection platform 109 may associate payment systems with the use of various criteria.

In one embodiment, the compilation platform 111 may create at least one media compilation by applying selected heuristic information to media items provided by the media items database 117. In a further embodiment, the compilation platform 111 may create at least one media compilation from media items of the media items database 117 by applying heuristic information determined from user preference, history, and/or criteria selections. Where there are payment systems associated with various criteria, the compilation platform 111 may work with the selection platform 109 to insert into the media compilation (a) one or more marks associated with the heuristic information, the directing user, or a combination thereof, (b) related content, (c) advertising information, and/or (d) a combination thereof.

In one embodiment, the heuristic platform 107 also determines one or more parameters associated with editing, synchronizing, presenting, or a combination thereof from the one or more parameters stored in the parameter database 113. More specifically, the heuristic platform 107, in connection with the interface platforms 103, can utilize the one or more parameters stored in the parameter database 113 to generate or more media compilations. The parameter database 113, the context data database 115, and/or the media items database 117 may exist independently, or in whole or part within the heuristic platform 107 and/or compilation platform 111. In one embodiment, where metadata is used to facilitate editing, the UEs 101 may include sensors to determine context data associated with the plurality of media items (e.g., location information, timing information, orientation, etc.). The system 100 may store such context data in the context data database 115 to further inform the creation of heuristic information.

The media items database 117 can be utilized for collecting and buffering a plurality of media items for making compilations. More specifically, the media items database 117 may include a plurality of media items (e.g., videos), one or more media segments, one or more customized media items (e.g., personalized video), or a combination thereof.

By way of example, the UEs 101, interface platforms 103, heuristic platform 107, selection platform 109, compilation platform 111, parameter database 113, context data database 115, and media items database 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

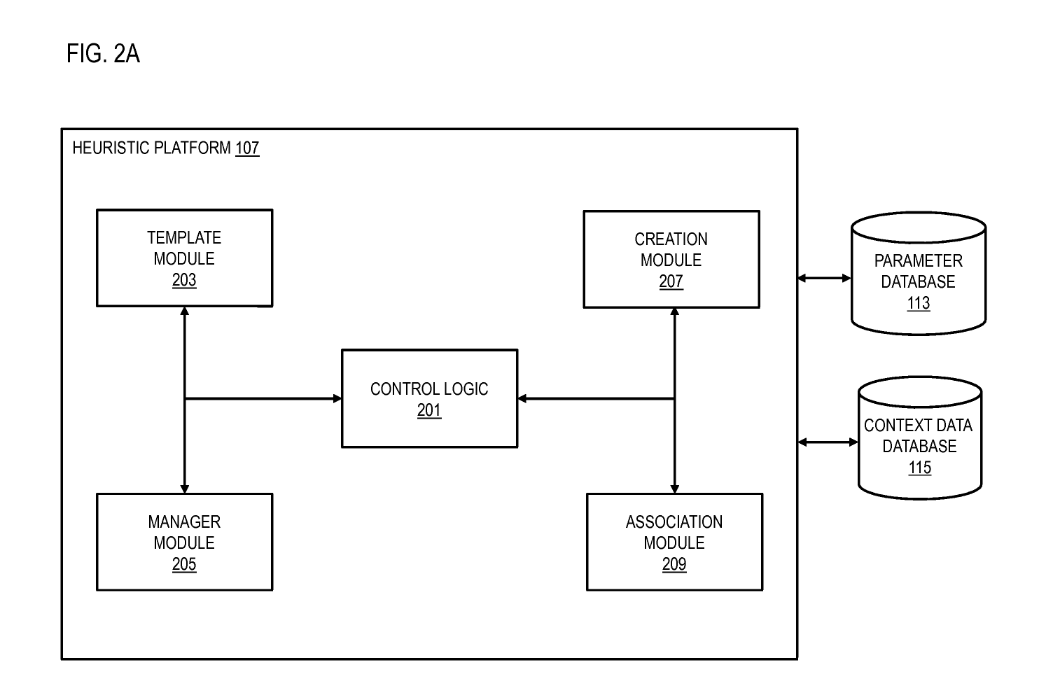

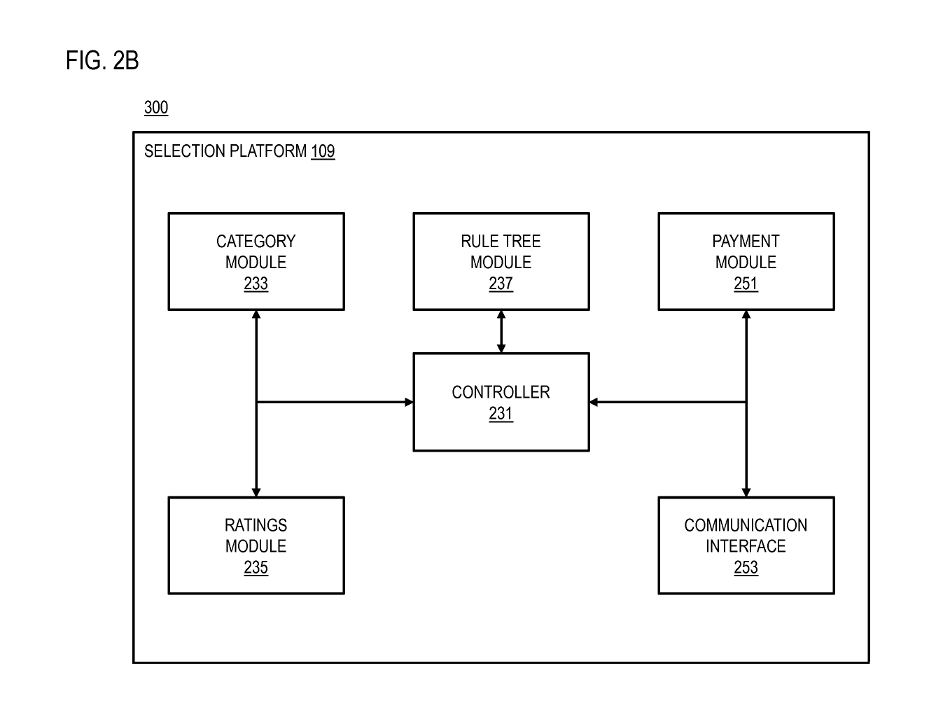

FIG. 2A is a diagram of the components of the heuristic platform 107, according to one embodiment. By way of example, the heuristic platform 107 includes one or more components for providing media editing according to directional heuristics. It is contemplated that the functions of these components may be combined in one or more components or performed by other components of equivalent functionality. In this embodiment, the heuristic platform 107 includes a control logic 201, template module 203, manager module 205, creation module 207, and an association module 209.

The control logic 201 executes at least one algorithm for executing functions of the heuristic platform 107. For example, the control logic 201 may interact with the template module 203 to create templates for directors to use to create heuristic information. In one embodiment, the templates may include various parameters as provided by the parameter database 113 for directing users to choose for various conditions. For instance, one or more templates may present sets of parameters for various types of events. For each type of event or scenario, one or more directing users may specify allowable ranges or values for the various parameters in the template. In one scenario, templates may include options for the directing user to enter heuristics for parameters including length of clip, angle of camera, how much of various elements to include, when to change to other angles, how often to switch angles, etc.

The control logic 201 and manager module 205 may help manage the parameters in parameter database 113. In one embodiment, the manager module 205 may also provide the range or values as described above for directorial users to select. The range or values may include unit information. In a further embodiment, the system 100 may update the manager module 205 with new parameters or parameters changes for use by other modules. The parameters managed by the manager module 205 are used by the templates created by the template module 203.

The control logic 201 may also interact with the creation module 207 to create heuristic information by processing media items. In one embodiment, this may include the creation module 207 processing media submitted by at least one directing user and creating a set of heuristic information based on the submitted media. In another embodiment, the creation module 207 may also engage the template module 203 to create one or more templates based on parameters triggered in the processing. In a further embodiment, the creation module 207 can use the processing to recommend more heuristic information or rules based on values selected in the template module 203, media submitted for processing, and/or raw media selected for editing.

Lastly, the control logic 201 may work with the association module 209 to associate the heuristic information with at least one directing user. The association module 209 may further associate the heuristic information with other criteria for future use by end users.

FIG. 2B is a diagram of the components of the selection platform 109, according to one embodiment. By way of example, the selection platform 109 includes one or more components for providing media editing according to directional heuristics. It is contemplated that the functions of these components may be combined in one or more components or performed by other components of equivalent functionality. In this embodiment, the selection platform 109 includes a controller 231, category module 233, ratings module 235, rule tree module 237, payment module 251, and communication interface 253.

The controller 231 executes at least one algorithm for executing functions of the heuristic platform 107. For one embodiment, the controller 231 may interact with the category module 233 to manage the categories allowed in the system. In one instance, categories include field types, such as events, director experience level, rating information, user profile information, etc. In a further embodiment, the category module 233 may maintain one or more field ontologies of the categories in the system so that the association module 209 may readily associate parameters and/or heuristic information with defined categories. The one or more field ontologies managed by the category module 233 may permit directorial users to map heuristic information to appropriate categories consistently in order to maintain the integrity of the categories. In an even further embodiment, the category module 233 may update the categories and/or field ontologies as fit.

The controller 231 may also work with the ratings module 235 to supply information to the category module 233. The ratings module 235 may receive, from UEs 101, ratings data for directorial users. For instance, there may be many classifications of directorial users. As discussed, the classifications may be portrayed as a rating from one to five stars. Alternately, classifications may be in groups such as, “Novice”, “Competent”, and “Expert.” These are just some examples of possible ratings schemes. The ratings module 235 may include a definition for each classification. In one embodiment, the ratings module 235 may track ratings as part of user profiles. In such a case, the ratings module 235 may automatically associate ratings or classification data with heuristic information submitted by one or more given users. In another case, the ratings module 235 may relate to the category module 233 in that the system 100 could upgrade one or more given users based on their contributions and/or ratings.

With categories defined by the category module 233 and ratings information supplied by the ratings module 235, the controller 231 may interact with the rule tree module 237 to organize the categories. In one embodiment, the rule tree module 237 may organize the categories in a tree structure through which a user can select a heuristic information associated with criteria and directing users to apply to media. In one example, the rule tree module 237 may express the tree structure in an XML format to be received at the UEs 101. The rule tree module 237 may generate the tree structure, regardless of whether the compilation is to form at the compilation platform 111 or UEs 101. In one scenario, the rule tree module 237 may not transmit or embed heuristic information in raw media sent to UEs 101. In such a case, the rule tree module 237 may generate the tree structure separately and permit users to browse and select appropriate rules based on the tree structure created by the interface platforms 103 at respective UEs 101.

In a further embodiment, the controller 231 may work with payment module 251 to associate one or more criteria or sets of heuristic information with one or more payment systems. For example, the controller 231 may associate a payment system with heuristic information that is associated with a professional directing user. In such a case, end users may pay to use certain heuristic information. In an even further embodiment, media compilations created using such heuristic information may include one or more marks associated with the heuristic information, the directing user, or a combination thereof. For example, controller 231, payment module 251, and the compilation platform 111 may ensure that a home video created using the heuristic information associated with a famous Hollywood director, carries a mark associated with the famous director. In another embodiment, users may gift to other end users, heuristic information associated with at least one directing user. In addition, entities associated with heuristic information may provide alternate services, such as hosting and/or advertising the media compilations made using their heuristic information. The entities could then charge for the alternate services.

Additionally, the controller 231 may utilize the communication interface 253 to communicate with other components of the selection platform 109, UEs 101, heuristic platform 107, compilation platform 111 and other components of the system 100. In one embodiment, the controller 231 may work with the communication interface 253 and interface platforms 103 at the UEs 101 to create various user interfaces. The communication interface 253 may include multiple means of communication. For example, the communication interface 253 may be able to communicate over SMS, internet protocol, instant messaging, voice sessions (e.g., via a phone network), or other types of communication.

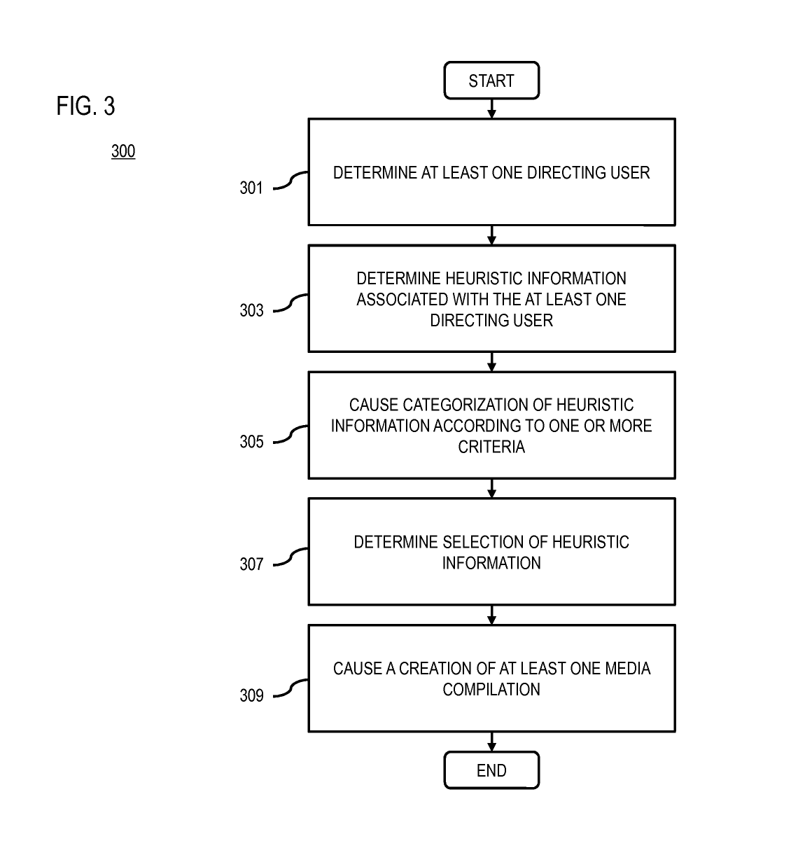

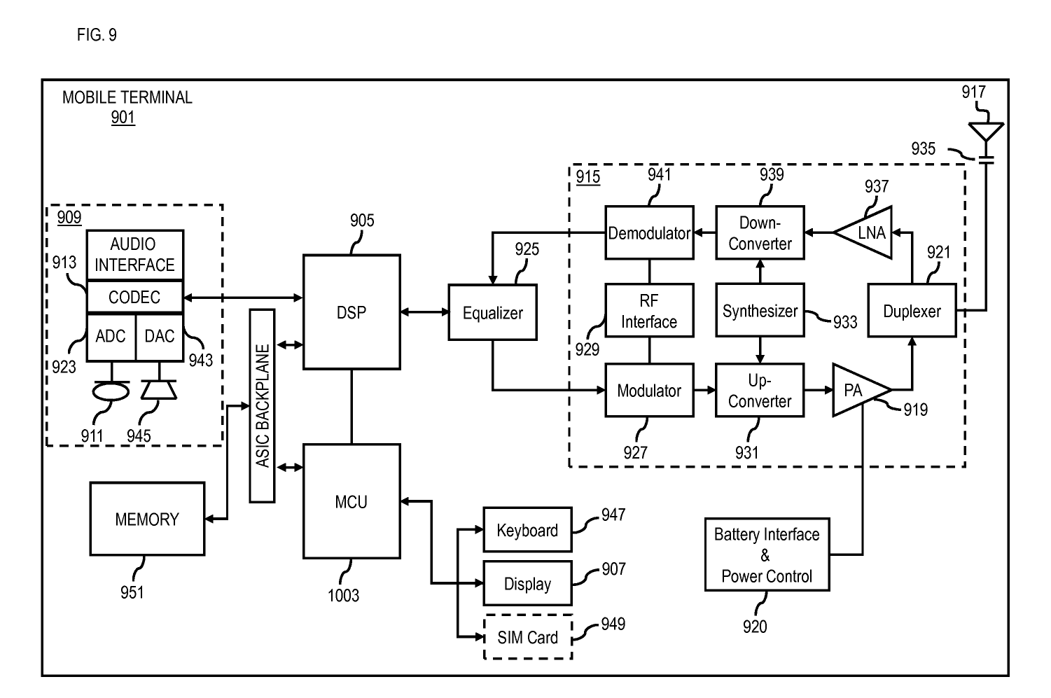

FIG. 3 is a flowchart of a process for editing media according to directional heuristics, according to one embodiment. In one embodiment, the heuristic platform 107 performs the process 300 and is implemented in, for instance, a chip set including a processor and a memory as shown in FIG. 9. In step 301, the heuristic platform 107 determines at least one directing user. In one embodiment, the heuristic platform 107 may receive the directing user from one or more UEs 101. For example, the interface platforms 103 may prompt selections of at least one directing user and relay the selection to the heuristic platform 107. Next, in step 303, the heuristic platform may determine heuristic information for creating at least one media compilation, wherein the heuristic information is associated with at least one directing user. In one embodiment, the heuristic information is specified based, at least in part, on one or more media editing parameters. As previously discussed, such parameters may include audio beats, fade effects, significant events, camera angle, duration, light range, ratios (people versus events), panning, tilt, precision, multi-channels versus single channels, object detection and priority, target audience, event types, etc.

In one embodiment, the heuristic platform 107 may determine heuristic information from the at least one directing user via one or more template editing forms. Alternately or in addition, the heuristic platform 107 may process and/or facilitate a processing of one or more media compilations, metadata associated with the one or more other media compilations, or a combination thereof associated with the at least one directing user to determine the heuristic information.

Then, at step 305, the selection platform 109 may cause, at least in part, a categorization of the heuristic information according to one or more criteria, wherein the one or more criteria include, at least in part, one or more event types, experience information associated with the at least one directing user, rating information associated with the at least one directing user, profile information associated with the at least one directing user, media compilation type, an/or a combination thereof. At step 307, the interface platforms 103 and heuristic platform 107 may determine a selection of heuristic information by at least one end user. In one embodiment, the heuristic platform 107 may further process and/or facilitate a processing of the one or more media items associated with the at least one end user, metadata associated with the one or more media items, or a combination thereof to cause, at least in part, a recommendation of the heuristic information, the at least one directing user, or a combination thereof.

Once the heuristic information is selected, the compilation platform 111 may process and/or facilitate a processing of the heuristic information to cause, at least in part, a creation of the at least one media compilation based, at least in part, on one or more media items associated with the at least one end user (step 309). In one embodiment, step 309 may include the compilation platform 111 causing, at least in part, an insertion of (a) one or more marks associated with the heuristic information, the at least one directing user, or a combination thereof; (b) related content; (c) advertising information; or (d) a combination thereof in the at least one media compilation.

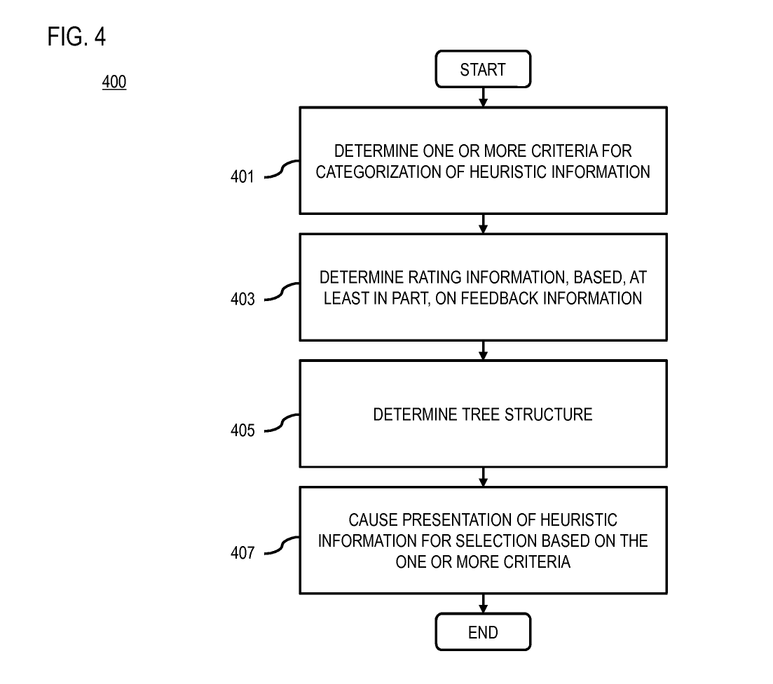

FIG. 4 is a flowchart of a process for causing categorization of heuristic information according to one or more criteria, for to one embodiment. In one embodiment, the selection platform 109 performs the process 400 and is implemented in, for instance, a chip set including a processor and a memory as shown in FIG. 9. In step 401, the selection platform 109 may determine one or more criteria for categorizing heuristic information. As discussed, criteria may include rating information associated with at least one directing user. For such an embodiment, the selection platform 109 may determine rating information based, at least in part, on feedback information from the at least one end user, one or more other end users, or a combination; and cause at least in part, an association of the rating information with the heuristic information, the at least one directing user, the at least one media compilation, or a combination thereof (step 403).

As previously discussed, the selection platform 109 causes categorization of heuristic information and a presentation of the heuristic information for selection. For step 405, once adequate information regarding criteria is gathered, the selection platform 109 may determine the categorization based, at least in part, on a tree structure, wherein the presentation is further based, at least in part, on the tree structure. For step 407, the interface platforms 103 and selection platform 109 may cause, at least in part, a presentation of the heuristic information for selection by the at least one end user based, at least in part, on the one or more criteria. In selecting the one or more criteria, the at least one end user also picks heuristic information for editing the media compilation.

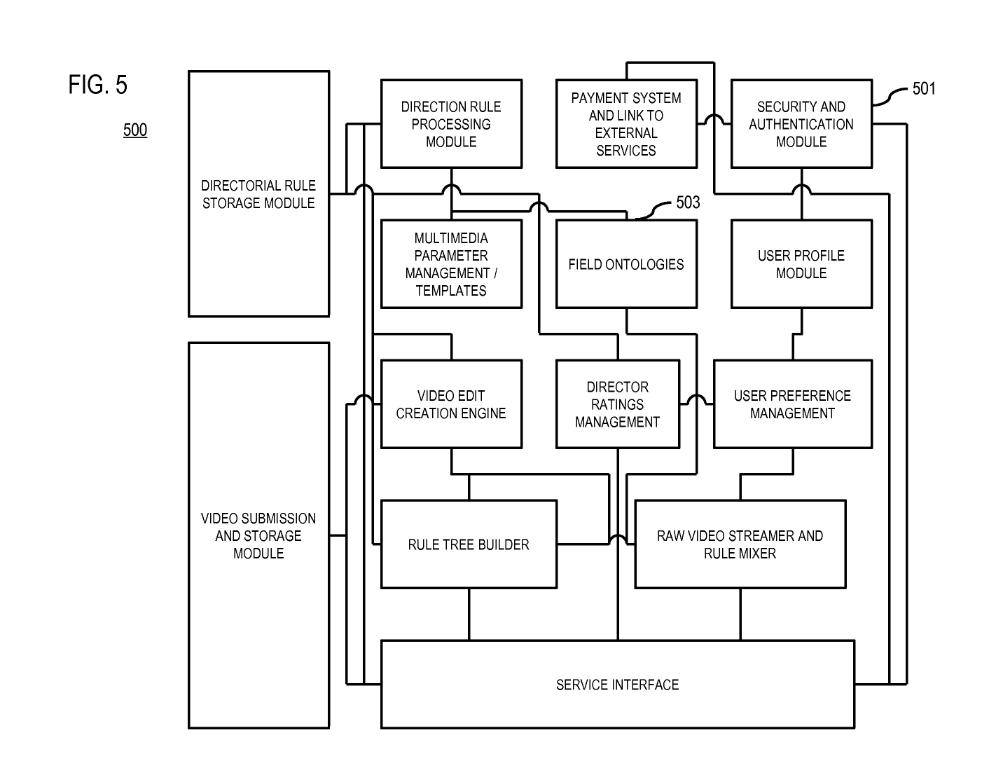

FIG. 5 is a framework for executing the processes of FIGS. 3-4, according to one embodiment. In this embodiment, framework 500 may create the media compilation either at UEs 101 and/or the compilation platform 111, based on capabilities of respective UEs 101 and the system 100 overall. In one embodiment, UEs 101 may communicate with other platforms in system 100 through interface platform 103. The system 100 may include a security and authentication module 501 to authenticate UEs 101. In one embodiment, UEs 101 may submit videos to the media items database 117 and seek media compilations made with heuristic information. To facilitate selection of heuristic information, the heuristic information may be associated with various criteria. Field ontologies 503 may categorize or organize the various criteria. In one embodiment, field ontologies 503 may be part of the selection platform 109.

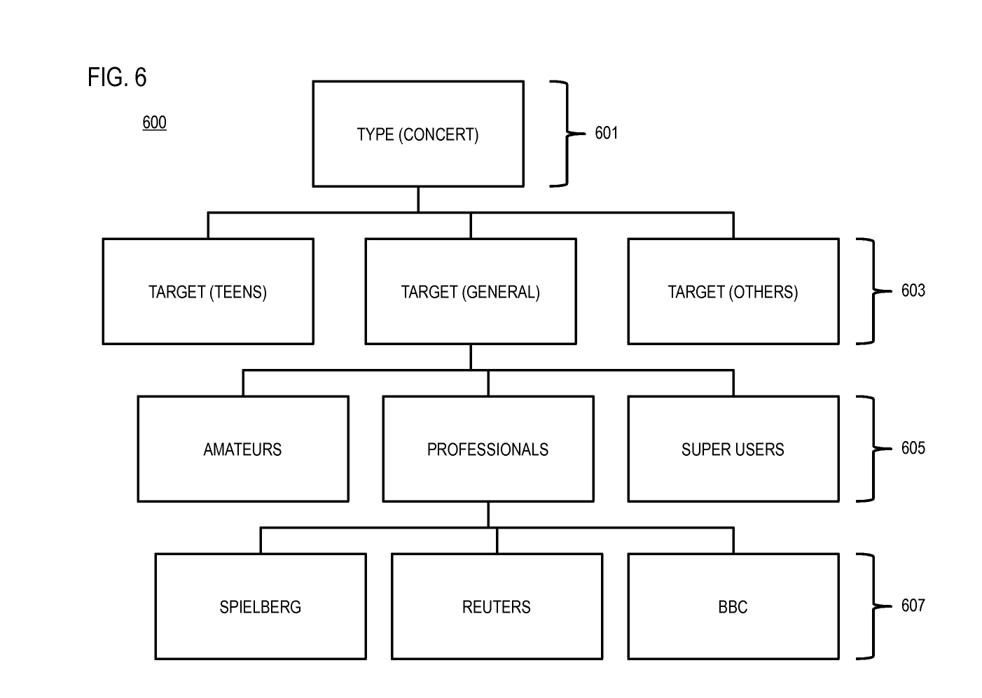

FIG. 6 is a tree structure for categorizing heuristic information, according to one embodiment. Tree structure 600 illustrates a possible tree structure flowing from the criteria, “event type.” The instance shown here, is specifically for event type, “concert.” In other words, at the first tier 601 of the tree structure 600, is one option: Concert. For the second tier 603, there are three options for the criteria, “target audience.” The three options are: teens, general, and others. The third tier 605 corresponds to directorial skill, breaking directorial skill into “amateurs”, “professionals”, and “super users.” The fourth tier 607 may then specify the criteria of media purpose, broken down into “Spielberg”, “Reuters”, and “BBC.” As described earlier, heuristic information is associated with each criteria and/or options for the criteria. By determining criteria selections at the interface platforms 103 and/or selection platform 109, the system 100 may edit the media compilations with heuristics that best suit user preferences. Categorizing the criteria permits a more streamlined process for directing users completing templates and end users selecting heuristic information.

The processes described herein for editing media according to directorial heuristics may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

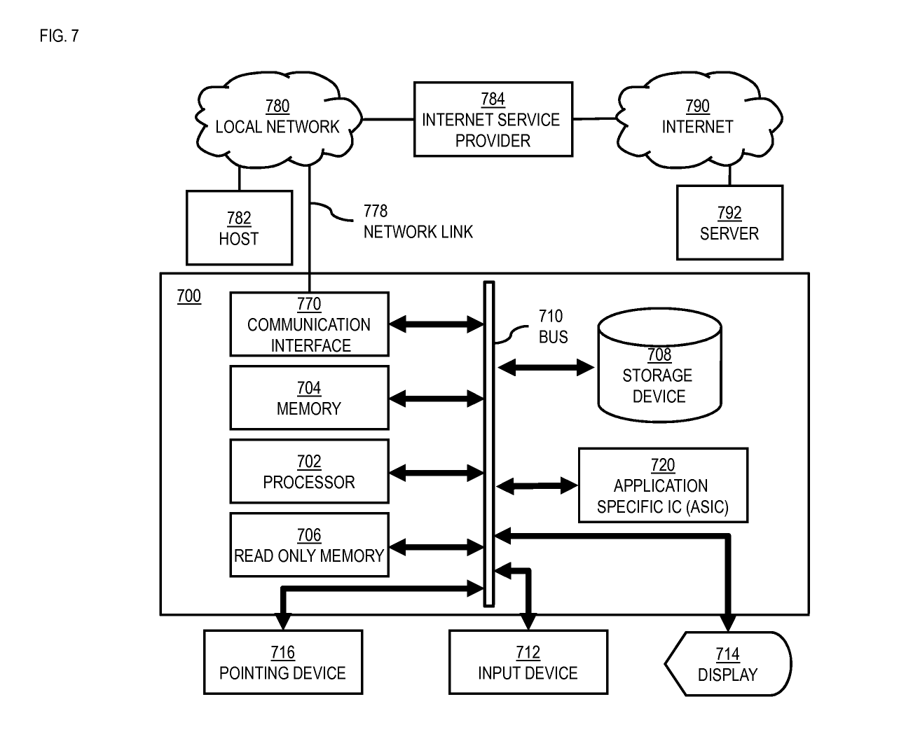

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to share items using audio as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of editing media according to directorial heuristics.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to editing media according to directorial heuristics. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for editing media according to directorial heuristics. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for editing media according to directorial heuristics, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for editing media according to directorial heuristics to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

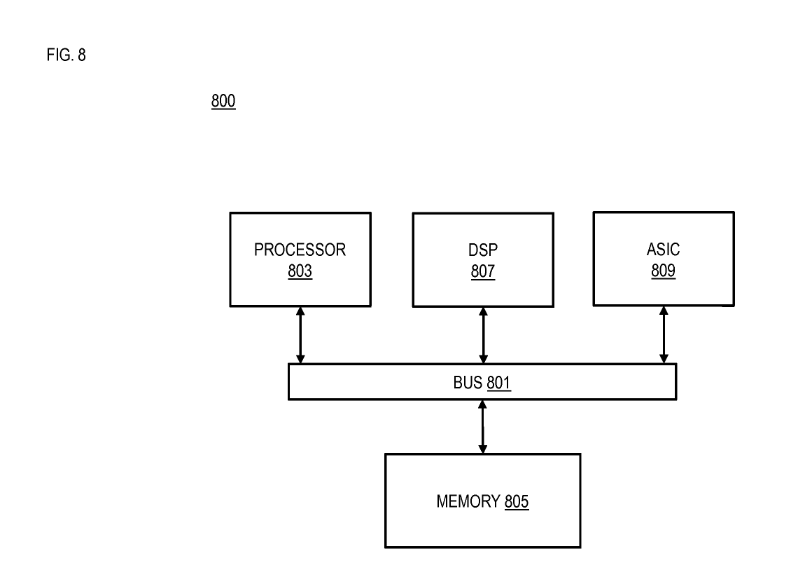

FIG. 8 illustrates a chip set or chip 800 upon which an embodiment of the invention may be implemented. Chip set 800 is programmed to share items using audio described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of editing media according to directorial heuristics.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to share items using audio. The memory 805 also stores the data associated with or generated by the execution of the inventive steps.

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of editing media according to directorial heuristics. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of editing media according to directorial heuristics. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to share items using audio. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of a selection of the heuristic information by at least one end user; and
a processing of the heuristic information to cause, at least in part, a creation of the at least one media compilation based, at least in part, on one or more media items associated with the at least one end user.

2. A method of claim 1, wherein the (1) data and/or (2) information and/or (3) at least one signal are further based, at least in part, on the following:
a categorization of the heuristic information according to one or more criteria; and
a presentation of the heuristic information for selection by the at least one end user based, at least in part, on the one or more criteria.

3. A method of claim 2, wherein the (1) data and/or (2) information and/or (3) at least one signal are further based, at least in part, on the following:
at least one determination of the categorization based, at least in part, on a tree structure,
wherein the presentation is further based, at least in part, on the tree structure.

4. A method of claim 1, wherein the one or more criteria include, at least in part, one or more event types, experience information associated with the at least one directing user, rating information associated with the at least one directing user, profile information associated with the at least one user, media compilation type, or a combination thereof.

5. A method of claim 4, wherein the (1) data and/or (2) information and/or (3) at least one signal are further based, at least in part, on the following:
at least one determination of the rating information based, at least in part, on feedback information from the at least one end user, one or more other end users, or a combination; and
an association of the rating information with the heuristic information, the at least one directing user, the at least one media compilation, or a combination thereof.

6. A method of claim 1, wherein the heuristic information is specified based, at least in part, on one or more media editing parameters.

7. A method of claim 1, wherein the (1) data and/or (2) information and/or (3) at least one signal are further based, at least in part, on the following:
at least one determination of the heuristic information from the at least one directing user via one or more template editing forms.

8. A method of claim 1, wherein the (1) data and/or (2) information and/or (3) at least one signal are further based, at least in part, on the following:
a processing of one or more other media compilations, metadata associated with the one or more other media compilations, or a combination thereof associated with the at least one directing user to determine the heuristic information.

9. A method of claim 1, wherein the (1) data and/or (2) information and/or (3) at least one signal are further based, at least in part, on the following:
a processing of the one or more media items associated with the at least one end user, metadata associated with the one or more media items, or a combination thereof to cause, at least in part, a recommendation of the heuristic information, the at least one directing user, or a combination thereof.

10. A method of claim 1, wherein the (1) data and/or (2) information and/or (3) at least one signal are further based, at least in part, on the following:
an insertion of (a) one or more marks associated with the heuristic information, the at least one directing user, or a combination thereof; (b) related content; (c) advertising information; or (d) a combination thereof in the at least one media compilation.

11. An apparatus comprising:
at least one processor; and
at least one memory including computer program code for one or more programs,
the at least one memory and the computer program code configured to, with the at least one processor, cause the apparatus to perform at least the following,
determine heuristic information for creating at least one media compilation, wherein the heuristic information is associated with at least one directing user;
determine a selection of the heuristic information by at least one end user; and
process and/or facilitate a processing of the heuristic information to cause, at least in part, a creation of the at least one media compilation based, at least in part, on one or more media items associated with the at least one end user.

12. An apparatus of claim 11, wherein the apparatus is further caused to:
cause, at least in part, a categorization of the heuristic information according to one or more criteria; and
cause, at least in part, a presentation of the heuristic information for selection by the at least one end user based, at least in part, on the one or more criteria.

13. An apparatus of claim 12, wherein the apparatus is further caused to:
determine the categorization based, at least in part, on a tree structure,
wherein the presentation is further based, at least in part, on the tree structure.

14. An apparatus of claim 12, wherein the one or more criteria include, at least in part, one or more event types, experience information associated with the at least one directing user, rating information associated with the at least one directing user, profile information associated with the at least one user, media compilation type, or a combination thereof.

15. An apparatus of claim 14, wherein the apparatus is further caused to:
determine the rating information based, at least in part, on feedback information from the at least one end user, one or more other end users, or a combination; and
cause, at least in part, an association of the rating information with the heuristic information, the at least one directing user, the at least one media compilation, or a combination thereof.

16. An apparatus of claim 11, wherein the heuristic information is specified based, at least in part, on one or more media editing parameters.

17. An apparatus of claim 11, wherein the apparatus is further caused to:
determine the heuristic information from the at least one directing user via one or more template editing forms.

18. An apparatus of claim 11, wherein the apparatus is further caused to:
process and/or facilitate a processing of one or more other media compilations, metadata associated with the one or more other media compilations, or a combination thereof associated with the at least one directing user to determine the heuristic information.

19. An apparatus of claim 11, wherein the apparatus is further caused to:
process and/or facilitate a processing of the one or more media items associated with the at least one end user, metadata associated with the one or more media items, or a combination thereof to cause, at least in part, a recommendation of the heuristic information, the at least one directing user, or a combination thereof.

20. An apparatus of claim 11, wherein the apparatus is further caused to:
cause, at least in part, an insertion of (a) one or more marks associated with the heuristic information, the at least one directing user, or a combination thereof; (b) related content; (c) advertising information; or (d) a combination thereof in the at least one media compilation.

21-48. (canceled)
